(19) United States
(12) Patent Application Publication
(10) Pub. No.: US 2001/0037712 A1
(43) Pub. Date: Nov. 8, 2001

(54) SCISSORS, CUTTER MECHANISM INCORPORATING THE SCISSORS AND PRINTING APPARATUS INCORPORATING THE CUTTING MECHANISM

(76) Inventors: SHIGEO FURUHATA, NAGANO (JP); TETSUO KOZAKAI, GIFU (JP)

Correspondence Address: John P. Scherlacher, Esq., HOGAN & HARTSON, L.L.P., Biltmore Tower, 500 South Grand Avenue, Ste. 1900, LOS ANGELES, CA, 90071, US

(21) Appl. No.: 08/938,906

(22) Filed: Sep. 26, 1997

(30) Foreign Application Priority Data
Sep. 27, 1996 (JP) 277521/2995
Sep. 30, 1996 (JP) 278912/1996

(51) Int. Cl. B26B 13/06; B26D 7/00

(52) U.S. Cl. 83/694; 30/254; 30/351; 83/607

(57) ABSTRACT

Scissors include a first cutting blade, a second cutting blade and a support shaft. The first cutting blade has a handle and is formed with a through hole. The second cutting blade has a handle and is formed with an insertion hole. The support shaft extends through the through hole of the first cutting blade and the insertion hole of the second cutting blade, for pivotally connecting the first cutting blade and the second cutting blade in a manner such that the first cutting blade and the second cutting blade can perform relative rotation about the support shaft with respect to each other to thereby perform a cutting operation. The second cutting blade has a spring nut portion formed in the form of a spring nut on an inner peripheral surface of the insertion hole. In another form of the invention, scissors include a pair of cutting blades each having a handle and arranged for relative rotation thereof with respect to each other to thereby perform a cutting operation, the pair of cutting blades each having a cutting edge and a cutting face parallel with the cutting edge, and a pivot member about which the pair of cutting blades perform the relative rotation. Each of the cutting blades has a bent portion along the cutting edge, the bent portion formed by bending a portion including the cutting face toward an opposed one of the cutting blades at a predetermined angle.

### BACKGROUND OF THE INVENTION

1. Field of the Invention

This invention relates to scissors having a fixed blade and a movable blade pivotally connected to each other by a support shaft, a cutter mechanism incorporating the scissors, and a printing apparatus incorporating the cutter mechanism.

2. Prior Art

FIGS. 1A and 1B show conventional typical scissors. The scissors 81 are constructed such that a fixed blade 82 and a movable blade 83 having respective handles 82a, 83a are pivotally connected to each other by a support shaft 84. One of the cutting blades to which the support shaft 84 is fixed is the fixed blade 82, whereas the other which is pivotally supported by the support shaft 84 is the movable blade 83. The movable blade 83 and the fixed blade 82 are riveted by the support shaft 84 which is inserted through holes formed through the two blades from the movable blade side and has its inserted flat end pressed down to form a pressed head, where by the fixed blade 82 and the movable blade 83 are connected to each other. The pressed head of the support shaft 84 is formed not only to pivotally connect or rivet the fixed blade 82 and the movable blade 83, but also to adjust contact pressure between the fixed blade 82 and the movable blade 83 such that an object can be favorably cut off and suitable cutting torque is obtained which is dependent on the manner of sliding of the blades 82, 83 on each other. Therefore, the pressed head of the support shaft 84 is formed by pressing down the inserted flat end thereof such that it is expanded on the outer surface of the fixed blade 82 through plastic deformation of the material forming the support shaft 84 to thereby fix the support shaft 84 to the fixed blade 82, and at the same time obtain suitable contact pressure by the spring force of the pressed head, which has been plastically deformed, within the limit of elastic deformation of the pressed head obtainable after the plastic deformation.

In the case of the above-mentioned conventional scissors 81, the operation of forming the pressed head requires delicate adjustment of the contact pressure with the plastic and elastic deformations in mind. Therefore, pressed heads are required to be formed one by one even for the same type of scissors. This makes it impossible to automate the riveting of blades by a support shaft, and the operation per se requires skills and time.

On the other hand, scissors have been proposed by Japanese Utility Model Publication (Kokoku) No. 3-4237, which include a pair of cutting blades, i.e. a fixed blade and a movable blade, each of which has its inner surface baked with coating of a fluorine resin for prevention of an adhesive from adhering thereto when an adhesive tape is cut off by the scissors.

However, the proposed scissors necessitate the baking of coating of a fluorine resin thereon, which complicates the manufacturing process, resulting in increased manufacturing costs of the scissors. Moreover, the coating of the fluorine resin is worn out or peeled off by repeated cutting operations (opening and closing of the cutting blades), which makes the cutting blades liable to degrading in its adhesion-preventing performance in a short period.

### SUMMARY OF THE INVENTION

It is a first object of the invention to provide scissors whose support shaft can be properly assembled with a fixed blade and a movable blade in a quick, simplified manner with properly controlled contact pressure between the blades, a cutter mechanism incorporating the scissors, and a printing apparatus incorporating the cutter mechanism.

It is a second object of the invention to provide scissors which can be manufactured at low costs, and continues to be free from adhesion of an adhesive thereto, a cutter mechanism incorporating the scissors, and a printing apparatus incorporating the cutter mechanism.

To attain the first object, according to a first aspect of the invention, there are provided scissors comprising:

a first cutting blade having a handle and formed with a through hole;

a second cutting blade having a handle and formed with an insertion hole; and

a support shaft extending through the through hole of the first cutting blade and the insertion hole of the second cutting blade, for pivotally connecting the first cutting blade and the second cutting blade in a manner such that the first cutting blade and the second cutting blade can perform relative rotation about the support shaft with respect to each other to thereby perform a cutting operation;

the second cutting blade having a spring nut portion formed in the form of a spring nut on an inner peripheral surface of the insertion hole.

According to the scissors of the first aspect of the invention, when the support shaft is inserted through the first blade and the second blade aligned to each other, with a predetermined pressure or force, an inserted end of the support shaft is fitted in the spring nut portion and engaged therewith in a retained manner. By controlling pressure or force required in inserting the shaft through the blades, contact pressure between the first cutting blade and the second cutting blade can be automatically adjusted. Further, within a range of elastic deformation of the spring nut portion, the resilient properties of the spring nut portion make it possible to fix the support shaft to the second cutting blade and at the same time properly maintain the contact pressure between the first cutting blade and the second cutting blade. Therefore, the amount of change in the spring force of the spring nut portion per amount of deformation of the spring nut portion can be made much smaller than the amount of change in the spring force of a pressed head of a support shaft of conventional scissors per amount of change in the deformation of the pressed head, and this permits the contact pressure to be adjusted in a stable and reliable manner. Moreover, the spring nut portion is slightly bent or projected outward, and hence kept from contact with the first cutting blade. As a result, the second cutting blade and the first cutting blade have a reduced mutual contact area around the support shaft, which makes it possible to reduce a loss of cutting torque ascribable to a friction between the second cutting blade and the first cutting blade in this area. That is, the cutting torque (force required for opening and closing the scissors) can be decreased without spoiling the cutting performance of the scissors.

Preferably, the first cutting blade and the second cutting blade are each formed from a hardened material in the form of a thin plate.

According to this preferred embodiment, there is no need to harden the first cutting blade and the second cutting blade after forming the blades by blanking, whereby the blades can be made with ease at reduced costs. Further, this permits the spring nut portion to have sufficient resilience, thereby permitting the contact pressure to be adjusted with more stability.

Preferably, the spring nut portion includes engaging ends, the support shaft including a shat, the shaft being formed with an annular groove in which the engaging ends of the spring nut portion are engaged.

According to this preferred embodiment, if the annular groove is formed by taking the amount of bending of the spring nut portion into account, the shaft can be pushed into the spring nut portion to a position in which the engaging ends formed on an inner peripheral portion of the spring nut portion are engaged in the annular groove, which makes it possible to obtain desired contact pressure between the first cutting blade and the second cutting blade. Further, this annular groove enables the support shaft to be positively retained in a more reliable manner.

Alternatively, the spring nut portion includes engaging ends, the support shaft including a shaft, the shaft being formed with an external thread in which the engaging ends of the spring nut portion are engaged.

According to this preferred embodiment, the shaft of the support shaft is formed with the external thread, which enables the support shaft to be positively retained and at the same time the contact pressure to be finely adjusted even after fitting the support shaft in the spring nut portion. That is, the support shaft can be rotated in both directions, thereby finely adjusting the contact pressure.

Preferably, the first cutting blade and the second cutting blade are formed by blanking of a plate material.

According to this preferred embodiment, outer shapes of the first cutting blade and the second cutting blade, including the insertion hole for inserting the support shaft therethrough and the spring nut portion, are formed by blanking, and cutting faces of the first and second cutting blades are made by blanking (cutting with a press) of the blades at a bevel. Therefore, the first cutting blade and the second cutting blade can be very easily formed in a short time period, which also contributes to reduction of manufacturing costs.

To attain the first object, according to a second aspect of the invention, there are provided scissors comprising:

a first cutting blade having a handle and formed with a through hole;

a second cutting blade having a handle and formed with an insertion hole;

a support shaft extending through the through hole of the first cutting blade and the insertion hole of the second cutting blade, for pivotally connecting the first cutting blade and the second cutting blade in a manner such that the first cutting blade and the second cutting blade can perform relative rotation about the support shaft with respect to each other to thereby perform a cutting operation; and

a spring nut secured on an outer surface of the second cutting blade and engaged with the support shaft.

According to the scissors of the second aspect of the invention, the spring nut is formed as a separate member, whereby although the number of component parts of the scissors is increased, the contact pressure between the first cutting blade and the second cutting blade can be stably adjusted even when the blades are made of thick plate materials which are difficult to utilize their resilient properties of an inner peripheral portion of the insertion hole for inserting the support shaft therethrough. Further, a desired spring nut can be selected to thereby adjust the contact pressure with ease.

To attain the first object, according to a third aspect of the invention, there are provided a cutter mechanism comprising:

scissors including:

a first cutting blade having a handle and formed with a through hole,

a second cutting blade having a handle and formed with an insertion hole, and

a support shaft extending through the through hole of the first cutting blade and the insertion hole of the second cutting blade, for pivotally connecting the first cutting blade and the second cutting blade in a manner such that the first cutting blade and the second cutting blade can perform relative rotation about the support shaft with respect to each other to thereby perform a cutting operation,

the second cutting blade having a spring nut portion formed in the form of a spring nut on an inner peripheral surface of the insertion hole; and

cutting operation means engaged with at least one of the handle of the first cutting blade and the handle of the second cutting blade, for causing the first cutting blade and the second cutting blade to perform the cutting operation, by way of the at least one of the handle of the first cutting blade and the handle of the second cutting blade.

According to the cutter mechanism of the third aspect of the invention, the scissors according to the first aspect of the invention are employed, whereby a force (cutting torque) required for a cutting operation by the cutting operation means and a force required for a non-cutting operation by the same can be made constant, and at the same time, the cutting torque can be decreased without spoiling the cutting performance of the scissors. Further, the scissors can be manufactured with ease. This makes it possible to exploit the advantage of the scissors as a cutter which can perform stable cutting for a long time period, and at the same time not only simplify the construction of the cutter mechanism but also reduce manufacturing costs thereof.

Preferably, the second cutting blade and the first cutting blade are each bent about the support shaft in a plane of the relative rotation of the first cutting blade and the second cutting blade.

According to this preferred embodiment, the scissors can be designed compact. Therefore, the scissors can be arranged in an intensive manner together with other components of the cutter mechanism, and this permits the whole cutter mechanism to be designed compact.

To attain the first object, according to a fourth aspect of the invention, there is provided a cutter mechanism comprising:

scissors including:

a first cutting blade having a handle and formed with a through hole,

a second cutting blade having a handle and formed with an insertion hole,

a support shaft extending through the through hole of the first cutting blade and the insertion hole of the second cutting blade, for pivotally connecting the first cutting blade and the second cutting blade in a manner such that the first cutting blade and the second cutting blade can perform relative rotation about the support shaft with respect to each other to thereby perform a cutting operation, and

a spring nut secured on an outer surface of the second cutting blade and engaged with the support shaft; and

cutting operation means engaged with at least one of the handle of the first cutting blade and the handle of the second cutting blade, for causing the first cutting blade and the second cutting blade to perform the cutting operation by way of the at least one of the handle of the first cutting blade and the handle of the second cutting blade.

According to the cutter mechanism of the fourth aspect of the invention, the scissors according to the second aspect of the invention are employed, which makes it possible to obtain the same effects as obtained by the cutter mechanism according to the third aspect of the invention described above.

To attain the first object, according to a fifth aspect of the invention, there is provided a printing apparatus comprising:

a cutter mechanism for cutting off a tape material to a predetermined length, the cutter mechanism including:

scissors, the scissors including:

a first cutting blade having a handle and formed with a through hole,

a second cutting blade having a handle and formed with an insertion hole, and

a support shaft extending through the through hole of the first cutting blade and the insertion hole of the second cutting blade, for pivotally connecting the first cutting blade and the second cutting blade in a manner such that the first cutting blade and the second cutting blade can perform relative rotation about the support shaft with respect to each other to thereby perform a cutting operation,

the second cutting blade having a spring nut portion formed in the form of a spring nut on an inner peripheral surface of the insertion hole, and

cutting operation means engaged with at least one of the handle of the first cutting blade and the handle of the second cutting blade, for causing the first cutting blade and the second cutting blade to perform the cutting operation via the at least one of the handle of the first cutting blade and the handle of the second cutting blade;

printing means for printing a portion of the tape material as desired; and

tape-feeding means for feeding the tape material printed by the printing means to bring a printed portion of the tape material to the cutter mechanism.

To attain the first object, according to a sixth aspect of the invention, there is provided a printing apparatus comprising:

a cutter mechanism for cutting off a tape material to a predetermined length, the cutter mechanism including:

scissors, the scissors including:

a first cutting blade having a handle and formed with a through hole,

a second cutting blade having a handle and formed with an insertion hole,

a support shaft extending through the through hole of the first cutting blade and the insertion hole of the second cutting blade, for pivotally connecting the first cutting blade and the second cutting blade in a manner such that the first cutting blade and the second cutting blade can perform relative rotation about the support shaft with respect to each other to thereby perform a cutting operation, and

a spring nut secured to an outer surface of the second cutting blade and engaged with the support shaft, and

cutting operation means engaged with at least one of the handle of the first cutting blade and the handle of the second cutting blade, for causing the first cutting blade and the second cutting blade to perform the cutting operation by way of the at least one of the handle of the first cutting blade and the handle of the second cutting blade;

printing means for printing a portion of the tape material as desired; and

tape-feeding means for feeding the tape material printed by the printing means to bring a printed portion of the tape material to the cutter mechanism.

According to the printing apparatus of the fifth aspect of the invention and the printing apparatus of the sixth aspect of the invention, the cutter mechanism of each of the printing apparatuses can be designed compact and manufactured at reduced costs, thereby permitting the printing apparatus to be designed more compact and manufactured at reduced costs. Further, since the cutter mechanism performs stable cutting for a long time period, the reliability of the printing apparatus can be improved.

To attain the second object, according to a seventh aspect of the invention, there are provided scissors comprising:

a pair of cutting blades each having a handle and arranged for relative rotation with respect to each other to thereby perform a cutting operation, the pair of cutting blades each having a cutting edge and a cutting face parallel with the cutting edge; and

a pivot member about which the pair of cutting blades perform the relative rotation;

each of the cutting blades having a bent portion along the cutting edge, the bent portion formed by bending a portion including the cutting face toward an opposed one of the cutting blades at a predetermined angle.

According to the scissors of the seventh aspect of the invention, each of the cutting blades is formed with a bent portion along the cutting edge, which is bent toward an opposed cutting blade at a predetermined angle. This provides a portion having a configuration similar or equivalent to a conventional “inner surface indentation” in an inner surface of each cutting blade with a line of bending at which the bent portion is bent as a center or bottom of the portion. That is, when the cutting edges slide past each other to thereby perform a cutting operation, the inner surfaces of the cutting blades are prevented from coming into contact with each other by the bend of the bent portions, whereby the inner surfaces of the cutting blades are always kept separate or spaced from each other. Therefore, when a tape or sheet coated with an adhesive is cut by the scissors, even if the adhesive is caused to lie inwardly over the cutting edge of a cutting blade by improper cutting of the adhesive, the adhesive is not pressed hard against the cutting blade by the opposed cutting blade. As a result, the adhesive is removed together with a cut-off portion of the tape or sheet when it is removed from the cutting blade. This prevents the adhesive from accumulating on the inner surfaces of the cutting blades to cause the blades to stick to each other and thereby disable the scissors from properly performing its cutting operation. Further, the inner surfaces of the cutting blades are spaced from each other and hence there is a favorable contact between the cutting edges, to thereby enhance the cutting performance thereof. Further, in contrast to the conventional “inner surface indentation”, there is no need to grind inner surface portions of cutting blades into a shape arcuate in cross-section, but the bent portions are easily formed simply by bending the cutting blades and at the same time the rigidity of the cutting blades can be improved by the bend.

Preferably, the predetermined angle is within a range of five to eight degrees.

If the predetermined angle of the bend is smaller than five degrees, the portion equivalent to the “inner surface indentation” is so shallow that the adhesive is liable to stick to the cutting blades, whereas if the predetermined angle of the bend is larger than eight degrees, the portion equivalent to the “inner surface indentation” is too deep so that the cutting edges are liable to wear, resulting in a shortened service life of the scissors.

Preferably, the bent portion is formed in a manner such that the bent portion increases in width from a root of the each of the cutting blades to a tip of the each of the cutting blades.

According to this preferred embodiment, in performing the cutting operation, as a contact point between the cutting edges of the cutting blades moves from a root side to a tip side of the cutting edges, the inner surfaces of the cutting blades are caused to be progressively separated or spaced from each other by the bent portions formed on the cutting blades such that the width of the each bend portion increases from the root side to the tip side. In other words, the bent portions constructed above enable each of the cutting blades to concurrently perform the functions of so-called “bend” and “twist” of a cutting blade which are conventionally provided by slightly bending the cutting blade along its length and slightly twisting the same around its longitudinal axis. Therefore, simply by providing a bent portion having a width progressively increased from the root side to the tip side for each cutting blade, scissors excellent in cutting performance can be designed while dispensing with processes for providing the “bend” and the “twist”. And further, the rigidity of the cutting blades is increased by forming the bent portions, and accordingly, even when the cutting blades are made of thin materials, it is possible to cause the blades to fully perform the functions of “bend” and “twist”.

Preferably, the pivot member comprises a support shaft pivotally connecting the pair of cutting blades, the each of the cutting blades having a cutout portion formed at a root of the bent portion in a manner such that the cutout portion is recessed from the cutting edge toward a back edge side in excess of a width of the bent portion.

According to this preferred embodiment, each cutting blade can be easily formed with a bent portion properly bent at the predetermined angle simply by bending a portion between the cutout portion and the tip of the blade along the cutting edge. In other words, since a root-side end of each bent portion is defined by the cutout portion, the bend of the bent portion is prevented from reaching a portion of the cutting blade around the support shaft opposed to a corresponding portion of its counterpart, and at the same time the bent portion can be angled constant over the whole length of thereof.

Preferably, the pivot member comprises a support shaft pivotally connecting the pair of cutting blades, one of the cutting blades to which the support shaft is secured being formed therethrough with an insertion hole, and having a spring nut portion formed in the form of a spring nut on an inner peripheral surface of the insertion hole.

According to this preferred embodiment, a pair of cutting blades and a support shaft therefor can be easily assembled by first aligning the cutting blades and then press-fitting the support shaft through the holes of the aligned cutting blades to the spring nut portion. Further, contact pressure between the cutting blades can be adjusted upon press-fitting the support shaft into the cutting blades.

Preferably, the each of the cutting blades is formed by blanking and bending of a plate material.

According to this preferred embodiment, after forming the outer shape of each cutting blade by blanking, the cutting face thereof is formed by blanking (cutting with a press) of each cutting blade at a bevel, and the bent portion thereof is formed by bending with a press. This enables the cutting blades to be made with ease. Especially, if a hardened material is used as a plate material for the cutting blades, heat treatment can be omitted and hence the cutting blades can be formed very easily.

To attain the second object, according to an eighth aspect of the invention, there is provided a cutter mechanism comprising:

scissors including:

a pair of cutting blades each having a handle and arranged for relative rotation with respect to each other to thereby perform a cutting operation, the pair of cutting blades each having a cutting edge and a cutting face parallel with the cutting edge, and

a pivot member about which the pair of cutting blades perform the relative rotation,

each of the cutting blades having a bent portion along the cutting edge, the bent portion formed by bending a portion including the cutting face toward an opposed one of the cutting blades at a predetermined angle; and

cutting operation means engaged with at least one of the handles of the pair of cutting blades, for causing the pair of cutting blades to perform the cutting operation by way of the at least one of the handles.

According to the cutter mechanism of the eighth aspect of the invention, since the scissors according to the seventh aspect of the invention are employed, favorable cutting operations can be performed without such control of the contact between the cutting blades as unconsciously carried out by the man when he operates typical scissors. Therefore, when the pair of cutting blades are caused to perform a cutting operation via a handle or handles by the use of the cutting operation means, the blades can perform as excellent cutting performance as ever, which makes it possible to design cutters which utilize the advantageous features of the scissors according to the seventh aspect of the invention which is capable of performing excellent cutting for a long time period. Further, the above cutter mechanism is particularly useful as a cutter mechanism for cutting adhesive tapes or the like since adhesive from the tapes hardly adheres to the cutting blades, whereby excellent cutting performance of the cutter mechanism can be maintained for a long time period. Moreover, since the scissors can be made with ease, the whole cutter mechanism can be manufactured at reduced costs.

Preferably, the pair of cutting blades are each bent about the support shaft in a plane of the relative rotation of the pair of cutting blades.

According to this preferred embodiment, the scissors can be designed compact, whereby the scissors can be arranged in an intensive manner together with other components of the cutter mechanism, and this permits the whole cutter mechanism to be designed compact.

To attain the second object, according to a ninth aspect of the invention, there is provided a printing apparatus comprising:

a cutter mechanism for cutting off a tape material to a predetermined length, the cutter mechanism including:

scissors, the scissors including:

a pair of cutting blades each having a handle and arranged for relative rotation with respect to each other to thereby perform a cutting operation, the pair of cutting blades each having a cutting edge and a cutting face parallel with the cutting edge, and

a pivot member about which the pair of cutting blades perform the relative rotation,

each of the cutting blades having a bent portion along the cutting edge, the bent portion formed by bending a portion including the cutting face toward an opposed one of the cutting blades at a predetermined angle, and

cutting operation means engaged with at least one of the handles of the pair of cutting blades, for causing the pair of cutting blades to perform the cutting operation by way of the at least one of the handles;

printing means for printing a portion of the tape material as desired; and

tape-feeding means for feeding the tape material printed by the printing means to bring a printed portion of the tape material to the cutter mechanism.

According to the printing apparatus of the ninth aspect of the invention, when a tape material is comprised of a printing tape coated with an adhesive, and a peel-off tape, the scissors can be prevented from being stuck to each other by adhering of the adhesive, whereby the merit of the scissors according to the seventh aspect of the invention can be fully utilized for a long time period. Further, since the cutter mechanism can be designed compact and manufactured at reduced costs, the whole printing apparatus can be designed compact and manufactured at reduced costs accordingly.

The above and other objects, features, and advantages of the invention will become more apparent from the following detailed description taken in conjunction with the accompanying drawings.

### BRIEF DESCRIPTION OF THE DRAWINGS

FIG. 1A is a plan view of conventional scissors;

FIG. 1B is a side view of the FIG. 1A scissors;

FIG. 2 is a plan view of a tape printing apparatus incorporating scissors and a cutter mechanism including the scissors, according to a first embodiment of the invention;

FIG. 3 is a longitudinal sectional view of the tape printing apparatus according to the first embodiment;

FIG. 4 is a perspective view of the cutter mechanism and component parts associated therewith, according to the first embodiment;

FIG. 5A is a plan view of the scissors according to the first embodiment;

FIG. 5B is an end view of the scissors according to the first embodiment;

FIG. 6 is an exploded perspective view of the scissors according to the first embodiment;

FIG. 7 is a sectional view taken on line A-A of FIG. 5A;

FIG. 8 is a sectional view taken on line B-B of FIG. 5A;

FIG. 9 is a plan view of scissors according to a second embodiment of the invention;

FIG. 10 is a sectional view taken on line C-C of FIG. 9; and

FIG. 11 is a side view of scissors according to a third embodiment of the invention.

### DETAILED DESCRIPTION

The invention will now be described in detail with reference to drawings showing embodiments thereof. In these embodiments, scissors, a cutter mechanism and a printing apparatus, according to the invention are applied to a tape-printing apparatus for printing desired characters and figures on a printing tape as tape material and cutting off the printed portion of the printing tape to a predetermined length to thereby form a separate piece of the printed portion in the form of a label.

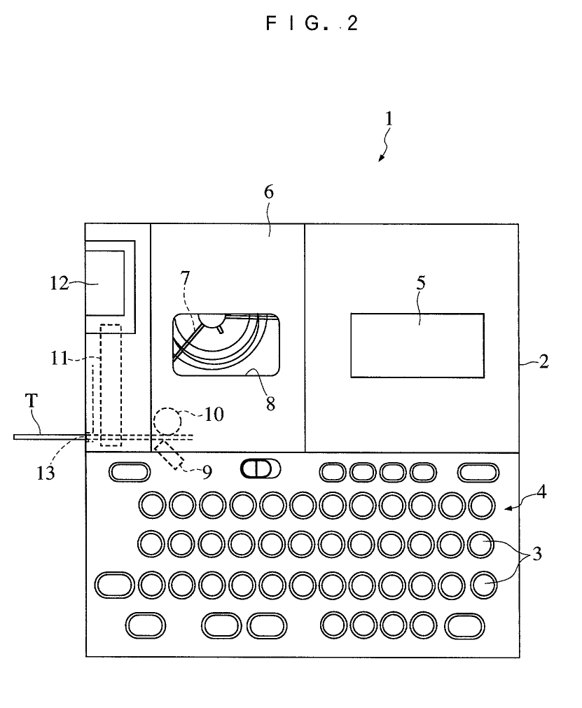

Referring first to FIG. 2, there is shown the tape-printing apparatus 1 which is comprised of a body casing 2 housing various components therein, an input block 4 having a plurality of input keys 3, 3, 3, . . . , for inputting printing information to the apparatus, a display 5 for displaying a line or lines of characters input via the input block 4 and other information, and a lid 6 which can be opened and closed. Under the lid 6, there is loaded a tape cartridge 7 containing a printing tape T. Whether the tape cartridge 7 is loaded can be confirmed by viewing the same via a confirmation window 8 formed in the lid 6.

Further, under the lid 6, there are arranged a print head 9 forming printing means in the vicinity of the tape cartridge 7 loaded, and a platen roller 10 forming tape-feeding means in a manner opposed to the print head 9. The printing tape T is rolled out from the tape cartridge 7 by the platen roller 10, printed by the print head 9, and delivered from the apparatus 1. On the other hand, at a left-side portion of the lid 6, there is provided a tape-cutting push button 12 for operating a cutter mechanism 11, referred to hereinafter. When the feeding of the printing tape T is stopped, the tape-cutting push button 12 is pushed or depressed, whereupon the printing tape T is cut to a predetermined length (printed portion + marginal white area). The body casing 2 is formed with a tape exit 13 adjacent to the cutter mechanism 11, via which the printing tape T is sent out of the apparatus.

The tape-printing apparatus 1 is operated in the following manner: First, the lid 6 is opened to load the tape cartridge 7 in the body casing 2, and then the lid 6 is closed. Then, a power switch, not shown, which is arranged at a right-side portion of the body casing 2, is turned on, and characters to be printed are input from the input block 4. A line or lines of the input characters are subjected to character conversion, as needed, and a predetermined key is operated to instruct the execution of printing. In response to the instruction, the print head 9 of a thermal transfer type prints the printing tape T with the line or lines of characters. As the printing proceeds, the printing tape T is advanced by the platen roller 10 until the printed portion of the printing tape T is sent out of the apparatus via the tape exit 13. When the printing is completed, the feeding of the printing tape T is stopped. Then, the tape-cutting push button 12 is depressed to cut the printing tape T to a predetermined length, and the resulting cut-off piece is discharged from the tape exit 13.

The printing tape T is a so-called peel-off tape-backed adhesive tape. The top of the printing tape is surface-treated for an excellent ink-spreading property, whereas the back of the same is coated with an adhesive and has a peel-off tape removably affixed thereto. When a portion of the peel-off tape affixed to the cut-off piece is peeled off or removed therefrom, the cut-off piece printed with characters and/or symbols can be affixed to a desired object as a label. There are provided several kinds of printing tape T, with various tape widths e.g. of 6 mm, 9 mm, 12 mm and 18 mm, for the tape-printing apparatus 1, as rolls each received within a tape cartridge 7 therefor.

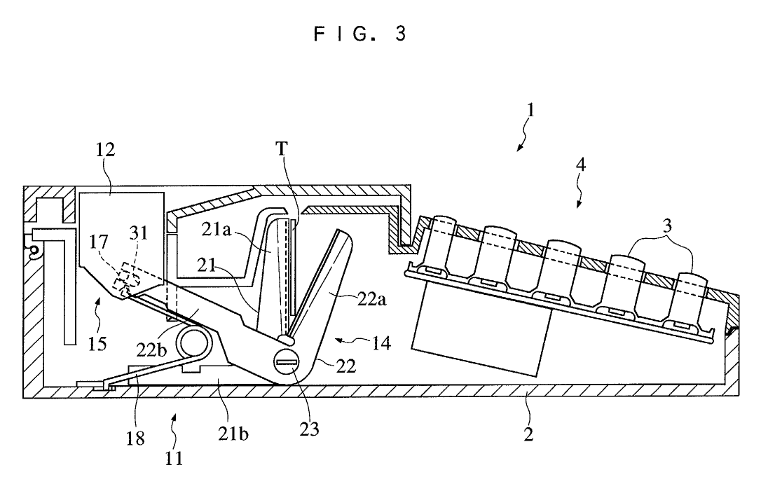

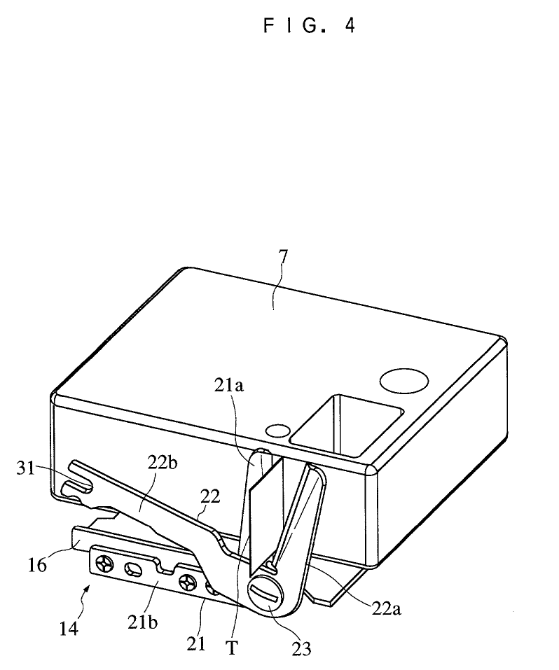

As shown in FIGS. 3 and 4, the cutter mechanism 11 includes scissors 14 bent into L shapes, and cutting operation means 15 for actuating the scissors 14 for cutting operations. The scissors 14 are comprised of a fixed blade (second cutting blade) 21 and a movable blade (first cutting blade) 22 each generally L-shaped, and a support shaft 23 pivotally supporting the fixed blade 21 and the movable blade 22a thereon at respective intermediate bent portions thereof, in a manner connecting the blades. The fixed blade 21 is formed by a blade 21a extending substantially perpendicularly upward from the intermediate bent portion thereof and a handle 21b integral with the blade 21a, which extends substantially horizontally from the intermediate bent portion thereof, as viewed in FIG. 3. Similarly, the movable blade 22 is formed by a blade 22a extending substantially perpendicularly upward from the intermediate bent portion thereof and a handle 22b integral with the blade 22a, which extends substantially horizontally from the intermediate bent portion thereof, as viewed in the same.

The fixed blade 21 is fixed to a chassis 16 at the handle 21b thereof (see FIG. 4), while the movable blade 22 is linked to the cutting operation means 15 at the handle 22b (see FIG. 3). The scissors 14 are arranged in a narrow gap between the tape cartridge 7 and a side plate of the body casing 2 and at the same time the blade 21a of the fixed blade 21 is arranged in a manner facing the printing tape T advanced from the tape cartridge 7 to the tape exit 13 (see FIGS. 2 and 4).

The cutting operation means 15 is constituted, as shown in FIG. 3, by the tape-cutting push button 12, an engaging pin 17 projecting inward from a side wall of the tape-cutting push button 12, and a spring 18 for urging the movable blade 22 in a rotational direction away from a portion of the printing tape T positioned in the tape exit 14. The tape-cutting push button 12 is mounted in the body casing 2 in a vertically slidable manner, and one end of the engaging pin 17 is engaged with an elongate slot 31 formed in an end of the handle 22b of the movable blade 22. On the other hand, the spring 18 is implemented by a torsion coiled spring or the like, with one end thereof attached to the body casing 2, and the other end attached to the bottom of the handle 22b of the movable blade 22. When the tape-cutting push button 12 is pushed downward, the movable blade 22 is moved in a cutting rotational direction toward the printing tape T by the urging force applied via the engaging pin 17 so that the movable blade 22 slides on the fixed blade 21 to perform the cutting operation. Then, when the tape-cutting push button 12 is released, the movable blade 22 is rotated in the rotational direction opposite to the cutting rotational direction by the urging force of the spring 18, while the tape-cutting push button 12 returns to its standby position by the force applied via the engaging pin 17.

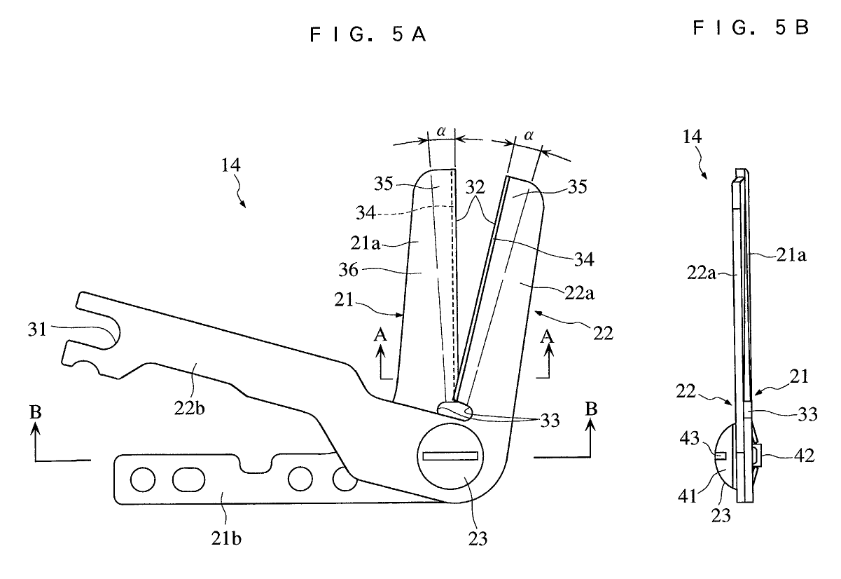

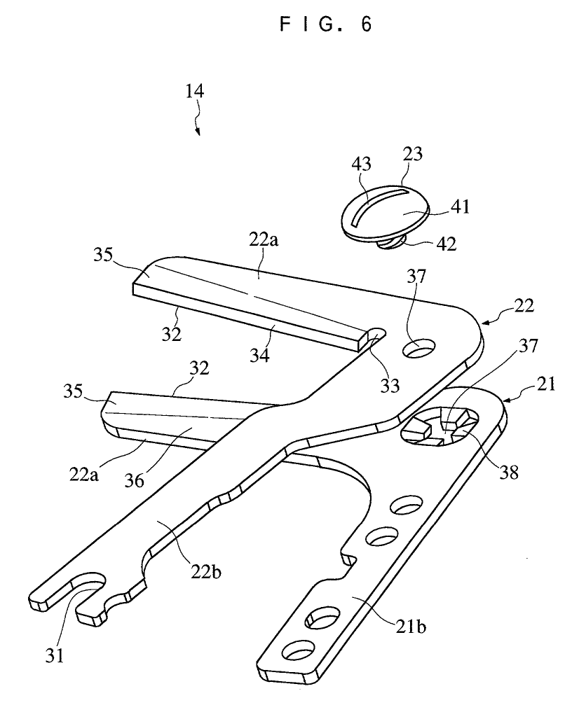

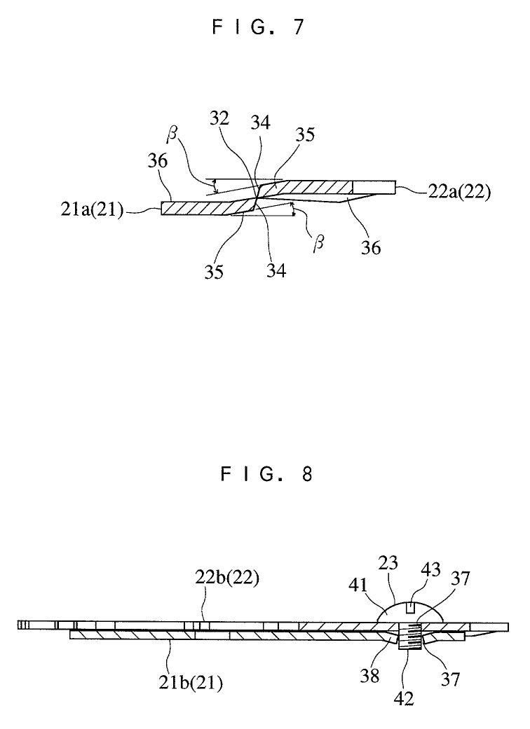

As shown in FIGS. 5A, 5B and 6, each of the blade 21a of the fixed blade 21 and the blade 22b of the movable blade 22 has a cutout portion 33 formed in a root portion thereof such that the cutout portion 33 is recessed from a cutting edge side to a back edge side, and between the cutout portion 33 and a tip of each blade, there is formed a cutting face 34 in parallel with a cutting edge 32. Further, each of the blades 21a, 22a has a bent portion 35 which includes the cutting face 34 and is formed by bending a portion of each of the cutting blades 21a, 22a extending along the cutting edge 32 between the cutout portion 33 and the tip of the blade toward the opposed blade at a slight angle. The cutout portion 33 is recessed in excess of a width of the bent portion 35. The width of the bent portion 35 increases from the cutout portion 33 to the tip of the blade such that a line of bending at which the bent portion 35 is bent forms an angle α with the cutting edge 32, as shown in FIG. 5A. More specifically, the bent portion 35 is inwardly bent at an angle βwith respect to a lateral plane of the blade 21a or 22a (main part of the blade), as shown in FIG. 7, and at the same time increased in width as it extends along its length to the tip of the blade such that the line of bending of the bent portion 35 forms the angle a with the cutting edge 32, so that the cutting edge of the blade 21a or 22a is more protruded toward that of the opposed blade as the bent portion 35 extends from the root to the tip of the blade.

Preferably, the above-mentioned angle β is in a range of five to eight degrees. According to experimental results, if the angle β is set to an angle smaller than 5 degrees, the adhesive of the printing tape T, described in detail hereinafter, becomes liable to adhere to the cutting blades. Inversely, if the angle β is set to an angle larger than 8 degrees, the adhesion of the adhesive from the tape T can be prevented, but the cutting edges become liable to wear to shorten the service life of the scissors.

As described above, the blades 21a, 22a of the fixed blade 21 and the movable blade 21, 22 are each formed with the bent portion 35, whereby what is generally called a clearance angle in the art of cutlery, i.e. a configuration similar to conventional “inner surface indentation” of scissors 14 can be easily provided for the blades 21a, 22a. As a result, the scissors 14 are improved in cutting performance and at the same time, when the opposed cutting edges 32, 32 of the fixed blade 21 and the movable blade 22 slide past each other to perform the cutting operation, the inner surfaces 36, 36 thereof are spaced from each other, so that cutting of the printing tape T coated with the adhesive does not lead to adhesion of the adhesive to the fixed blade 21 or the movable blade 22. For example, even if the adhesive is caused to lie inwardly over the cutting edge of the fixed blade 21 (or the movable blade 22) by the cutting of the printing tape T (through closing of the scissors), the adhesive is not pressed hard against the fixed blade 21 (or the movable blade 22) by the movable blade 22 (or the fixed blade 21) and hence the adhesive does not adhere to the inner surface 36 of the fixed blade 21 (or the movable blade 22). Even if the adhesive lightly adheres, the adhesive is removed together with the printing tape T when the movable blade 22 is moved away from the fixed blade 21 or the cut-off portion of the printing tape T is taken away.

This makes it possible to prevent the adhesive from accumulating on the inner surfaces 36, 36 of the fixed blade 21 and the movable blade 22 and thereby causing the blades 21, 22 to stick to each other to disable the scissors from properly performing its cutting operation. Especially, assuming that scissors are mounted in a device or apparatus as in the present embodiment, it is impossible for the user to dismantle the device or apparatus to remove the adhesive adhering to the blades. This makes the scissors 14 (cutter mechanism 11) according to the present embodiment very useful as scissors to be incorporated in the device or apparatus.

Further, differently from the conventional “inner surface indentation” of scissors in its original sense, which is formed by grinding portions of the inner surfaces 36, 36 of the blades of the scissors 14, the “inner surface indentation” of the present embodiment is not only easy to machine but also has a function of increasing the rigidity of the blades 21a, 22a per se through the bending of the same, which makes it possible to make the blades 21a, 22a of relatively thin materials with no cutting performance penalty. More specifically, the fixed blade 21 and the movable blade 22 can be made of a hardened material which can be worked with a press (e.g. a material having a thickness equal to or smaller than 0.8 mm). That is, the outer shapes of the fixed blade 21 and the movable blade 22 are formed by blanking, the cutting faces 34 of the same are also cut at a bevel by blanking with a press, and further, the bent portions 35 thereof are formed by bending with a press before or after forming the cutting faces 34. In such a case, hardening (heat treatment) process or the like after assembly can be omitted, and the fixed blade 21 and the movable blade 22 can be very easily manufactured by press working. It goes without saying that after blanking of the outer shapes of the fixed blade 21 and the movable blade 22, the cutting faces 34 alone may be finished by grinding. As a result, the scissors 14 (the cutter mechanism 11) can be designed compact and can be manufactured at reduced costs, which enables the tape printing apparatus 1 to be reduced in manufacturing cost and size.

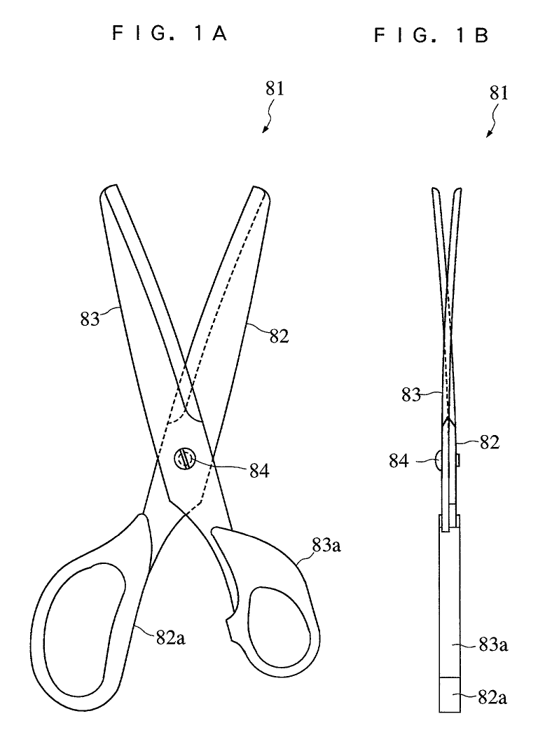

In the case of typical scissors (see FIG. 1), when the cutting edges of the fixed blade and movable blade thereof are brought into point-to-point contact with each other from the root side to the tip side of the blades to carry out a cutting operation, the farther the contact point between the cutting edges (edge-to-edge crossing point) moves away from the support shaft, the more compliant (flexible) the fixed blade and the movable blade become, which tends to cause a faulty cutting operation. Therefore, the fixed blade and the movable blade are each provided in advance with “bend” i.e. a slight bend of each blade toward the opposed blade and “twist” i.e. a twist of each cutting edge side toward the opposed blade with respect to the back edge side, so as to make the contact pressure between the blades higher as the edge-to-edge crossing point moves away from the support shaft.

According to the present embodiment, each of the bent portions 35 is formed such that the width thereof increases from the cutout portion 33 to the tip of the blade such that the line of bending forms an angle a with the cutting edge as shown in FIG. 5A whereby the tip of each cutting edge is more protruded toward the opposed blade than the root portion of the same. Therefore, as the edge-to-edge crossing point or contact point between the blades 21 and 22 moves farther from the support shaft 23, the contact pressure between the blades becomes higher, whereby the fixed blade 21 and the movable blade 22 can be imparted with the same functions as performed by the “bends” and “twists” of conventional cutting blades. As a result, if only the blades 21a, 22a are formed with the bent portions 35, there is no need to machine the blades 21a, 22a to provide the “bend” and “twist” therefor, which makes it possible to manufacture the fixed blade 21 and the movable blade 22 with ease. It should be noted that the cutout portions 33 provided for the blades 21a, 22a enables the bent portions 35 to be easily formed without adversely affecting the function of the support shaft 23.

Next, the configuration of the support shaft 23 and component parts associated with the same will be described with reference to FIGS. 6 and 8. The support shaft 23 is comprised of a head 41 and a shaft 42, and fixed to the fixed blade 21 in a state in which the shaft 42 extends through a through hole 37 of the movable blade 22. That is, the movable blade 22 is pivotally sandwiched by the head 41 and the fixed blade 21 with the shaft 42 extending therebetween, whereby the contact pressure between the fixed blade 21 and the movable blade 22 is properly maintained. The support shaft 23 has a thread-like configuration with its head 41 formed with a slot 43 for a screwdriver, and the shaft 42 formed with an external thread.

On the other hand, an inner peripheral portion of a through hole 37 of the fixed blade 21 through which the support shaft 23 extends is formed with a spring nut portion 38. The spring nut portion 38 is constructed by radially cutting a plurality of incisions in the inner peripheral portion defining the through hole 37 at circumferentially-spaced intervals into the shape of a spring nut. As shown in FIG. 8, when the support shaft 23 is press-fitted into the through hole 37, the support shaft 23 is inserted into the spring nut portion 38 in a manner forcing the spring nut portion 38 to open toward the outside whereby the support shaft 23 is fixed to the fixed blade 21. That is, the spring nut portion 38 has engaging ends thereof fitted into a groove of the external thread formed on the shaft 42, so that the support shaft 23 is firmly held in position or retained in the spring nut portion 38 by the spring force of the nut portion 38. The support shaft 23 is press-fitted with the contact pressure between the fixed blade 21 and the movable blade 22 in mind. If fine adjustment of the contact pressure is required at a final step, the support shaft 23 can be rotated in both directions to effect the fine adjustment. If the fine adjustment of the contact pressure is not required, the shaft 42 of the support shaft 23 may be formed with one or a plurality of annular grooves instead of the external thread. However, unless the material of the support shaft 23 is extremely hard, such an external thread or annual grooves may be omitted.

As described above, since the through hole 37 of the fixed blade 21 receiving the support shaft 23 is formed with the spring nut portion 38, it is possible to assemble the scissors 14 and at the same time adjust the contact pressure between the fixed blade 21 and the movable blade 22, simply by press-fitting the support shaft 23 into the fixed blade 21 and the movable blade 22a with a predetermined pressure or force. In contrast to conventional scissors 14 in which the support shaft 23 is assembled thereto by pressing down the inserted end thereof to form a pressed head, the fixing of the support shaft 23 to the fixed blade 21 and the adjusting of the contact pressure between the blades are both performed by utilizing the spring force of the spring nut portion 38, which makes it possible to routinely and easily adjust the contact pressure without skill, and at the same time prevent the support shaft 23 from becoming loose.

As a result, it is possible to mass-produce the scissors 14 (the cutter mechanism 11) which maintains excellent cutting performance for a long time period, whereby the scissors 14 (the cutter mechanism 11) having stable cutting performance can be manufactured at reduced costs. This makes it possible to attain reduction of costs for manufacturing the tape printing apparatus 1 and at the same time improve the durability of the same or prolong the service life thereof.

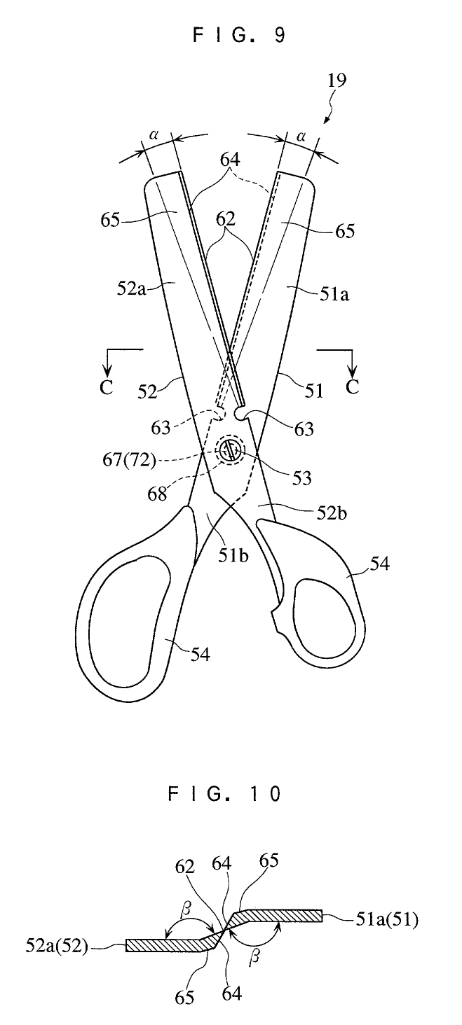

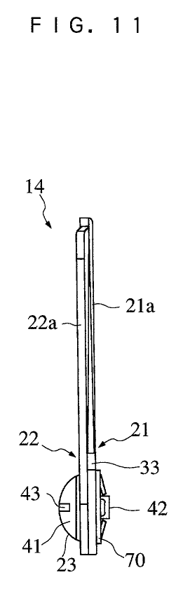

Next, scissors according to a second embodiment of the invention will be described with reference to FIGS. 9 and 10. The scissors 19 are of a typical type which include a fixed blade 51, a movable blade 52 crossing the fixed blade 51 to form an X shape, and a support shaft 53 for pivotally connecting the fixed blade 51 and the movable blade 52 at respective intermediate portions thereof. Similarly to the first embodiment, the fixed blade 51 and the movable blade 52 are comprised of blades 51a, 52a, and handles 51b, 52b integrally formed with the blades 51a, 52a, respectively. Further, the handles 51b and 52b are provided with respective grip covers 54, 54.

Similarly to the first embodiment, the blades 51a and 52a of the fixed and movable blades 51 and 52 each have a cutout portion 63 formed in at a root portion of a cutting edge 62a, and between each cutout portion 63 and a tip of each blade, there is formed a cutting face 64 in parallel with the cutting edge 62. Each of the blades 51a and 52a is formed with a bent portion 65 extending from the cutout portion to the tip thereof. The width of the bent portion 65 increases from the cutout portion 63 to the tip of the blade such that a line of bending at which the bent portion 65 is bent forms an angle α with the cutting edge 62, as shown in FIG. 9. More specifically, the bent portion 65 is inwardly bent at an angle β with respect to a lateral plane of the blade 51a or 52a (main part of the blade), as shown in FIG. 10, and at the same time increased in width as it extends along its length to the tip of the blade such that the line of bending of the bent portion 65 forms the angle α with the cutting edge 62. Similarly, a peripheral portion of a through hole 67 formed through the fixed blade 51 through which the support shaft 53 extends is formed with a spring nut portion 68, and a shaft 72 of the support shaft 53 is formed with an external thread. The support shaft 53 is press-fitted via a through hole formed through the movable blade 52 into the through hole 67 of the fixed blade 51 to be fixed to the spring nut portion 68 in a state retained therein.

In such scissors 19, similarly to the scissors according to the first embodiment, by providing the bent portions 65 for the fixed blade 51 and the movable blade 52, a configuration similar to a conventional “inner surface indentation” of typical scissors can be easily formed. This improves cutting performance of the scissors, and prevents an adhesive from adhering to the fixed blade 51 and the movable blade 52 when a tape or a sheet coated with the adhesive is cut by the scissors, thereby making the scissors 19 according to the present embodiment very useful in cutting adhesive tapes.

Further, since the bent portions 65 are each formed such that the width thereof increases forming the angle α between the line of bending and the cutting edge as shown in FIG. 9, the fixed blade 51 and the movable blade 52 can be imparted with the same functions as performed by the “bends” and “twists” of the conventional scissors. Moreover, the blades 51a and 52a can be made of relatively thin materials, and the fixed blade 51 and the movable blade 52 can be manufactured with ease.

Further, sine the through hole 67 of the fixed blade 51 receiving the support shaft 53 is formed with the spring nut portion 68, it is possible to assemble the scissors 19 and at the same time adjust the contact pressure between the fixed blade 51 and the movable blade 52, simply by press-fitting the support shaft 53 into the through hole 67 with a predetermined pressure or force. Therefore, the contact pressure can be routinely adjusted with ease in a simplified manner without skill, whereby the scissors 19 excellent in cutting performance can be made at reduced costs.

FIG. 11 shows scissors according to a third embodiment of the invention. This embodiment is distinguished from the first embodiment only in that a spring nut portion 70 is not integrally formed with a fixed blade but is formed as a separate member. Therefore, the through hole formed through the fixed blade is a simple through hole circular in transverse cross section. Since the other component elements and parts of the scissors according to the present embodiment are similar to those according to the first embodiment described above, some of them are designated by identical reference numerals, and detailed description thereof is omitted.

In the above embodiments, although description is made of scissors comprised of blades having a unique construction, this is not limitative, but the configuration of the support shaft and component parts associated therewith according to the invention can be applied to scissors comprised of blades having a typical or conventional construction (see FIG. 1).

It should be noted that although in the above embodiments the bent portion is formed in a manner such that the width thereof increases toward the tip, the bent portion may be formed with uniform width, with the bending angle β diminishing toward the tip. The scissors according to the invention can be applied to Japanese-style hand-held scissors.

It is further understood by those skilled in the art that the foregoing are preferred embodiments of the invention, and that various changes and modification may be made without departing from the spirit and scope thereof.

What is claimed is:

1. Scissors comprising:
a first cutting blade having a handle and formed with a through hole;
a second cutting blade having a handle and formed with an insertion hole; and
a support shaft extending through said through hole of said first cutting blade and said insertion hole of said second cutting blade, for pivotally connecting said first cutting blade and said second cutting blade in a manner such that said first cutting blade and said second cutting blade can perform relative rotation about said support shaft with respect to each other to thereby perform a cutting operation;
said second cutting blade having a spring nut portion formed in the form of a spring nut on an inner peripheral surface of said insertion hole.

2. Scissors according to claim 1, wherein said second cutting blade and said first cutting blade are each formed from a hardened material in the form of a thin plate.

3. Scissors according to claim 1 or 2, wherein said spring nut portion includes engaging ends, said support shaft including a shat, said shaft being formed with an annular groove in which said engaging ends of said spring nut portion are engaged.

4. Scissors according to claim 1 or 2, wherein said spring nut portion includes engaging ends, said support shaft including a shaft, said shaft being formed with an external thread in which said engaging ends of said spring nut portion are engaged.

5. Scissors according to claim 1 or 2, wherein said first cutting blade and said second cutting blade are formed by blanking of a plate material.

6. Scissors comprising:
a first cutting blade having a handle and formed with a through hole;
a second cutting blade having a handle and formed with an insertion hole;
a support shaft extending through said through hole of said first cutting blade and said insertion hole of said second cutting blade, for pivotally connecting said first cutting blade and said second cutting blade in a manner such that said first cutting blade and said second cutting blade can perform relative rotation about said support shaft with respect to each other to thereby perform a cutting operation; and
a spring nut secured on an outer surface of said second cutting blade and engaged with said support shaft.

7. Scissors according to claim 5, wherein said first cutting blade and said second cutting blade are formed by blanking of a plate material.

8. A cutter mechanism comprising:
scissors including a first cutting blade having a handle and formed with a through hole,
a second cutting blade having a handle and formed with an insertion hole, and
a support shaft extending through said through hole of said first cutting blade and said insertion hole of said second cutting blade, for pivotally connecting said first cutting blade and said second cutting blade in a manner such that said first cutting blade and said second cutting blade can perform relative rotation about said support shaft with respect to each other to thereby perform a cutting operation, said second cutting blade having a spring nut portion formed in the form of a spring nut on an inner peripheral surface of said insertion hole; and
cutting operation means engaged with at least one of said handle of said first cutting blade and said handle of said second cutting blade, for causing said first cutting blade and said second cutting blade to perform said cutting operation, by way of said at least one of said handle of said first cutting blade and said handle of said second cutting blade.

9. A cutter mechanism according to claim 8, wherein said second cutting blade and said first cutting blade are each bent about said support shaft in a plane of said relative rotation of said first cutting blade and said second cutting blade.

10. A cutter mechanism comprising:
scissors including:
a first cutting blade having a handle and formed with a through hole,
a second cutting blade having a handle and formed with an insertion hole,
a support shaft extending through said through hole of said first cutting blade and said insertion hole of said second cutting blade, for pivotally connecting said first cutting blade and said second cutting blade in a manner such that said first cutting blade and said second cutting blade can perform relative rotation about said support shaft with respect to each other to thereby perform a cutting operation, and
a spring nut secured on an outer surface of said second cutting blade and engaged with said support shaft; and
cutting operation means engaged with at least one of said handle of said first cutting blade and said handle of said second cutting blade, for causing said second cutting blade and said first cutting blade to perform said cutting operation, by way of said at least one of said handle of said first cutting blade and said handle of said second cutting blade.

11. A cutter mechanism according to claim 8, wherein said second cutting blade and said first cutting blade are each bent about said support shaft in a plane of said relative rotation of said first cutting blade and said second cutting blade.

12. A printing apparatus comprising:
a cutter mechanism for cutting off a tape material to a predetermined length, said cutter mechanism including:
scissors, said scissors including:
a first cutting blade having a handle and formed with a through hole,
a second cutting blade having a handle and formed with an insertion hole, and
a support shaft extending through said through hole of said first cutting blade and said insertion hole of said second cutting blade, for pivotally connecting said first cutting blade and said second cutting blade in a manner such that said first cutting blade and said second cutting blade can perform relative rotation about said support shaft with respect to each other to thereby perform a cutting operation,
said second cutting blade having a spring nut portion formed in the form of a spring nut on an inner peripheral surface of said insertion hole, and
cutting operation means engaged with at least one of said handle of said first cutting blade and said handle of said second cutting blade, for causing said second cutting blade and said first cutting blade to perform said cutting operation by way of said at least one of said handle of said first cutting blade and said handle of said second cutting blade;
printing means for printing a portion of said tape material as desired; and
tape-feeding means for feeding said tape material printed by said printing means to bring a printed portion of said tape material to said cutter mechanism.

13. A printing apparatus comprising:
a cutter mechanism for cutting off a tape material to a predetermined length, said cutter mechanism including:
scissors, said scissors including:
a first cutting blade having a handle and formed with a through hole,
a second cutting blade having a handle and formed with an insertion hole,
a support shaft extending through said through hole of said first cutting blade and said insertion hole of said second cutting blade, for pivotally connecting said first cutting blade and said second cutting blade in a manner such that said first cutting blade and said second cutting blade can perform relative rotation about said support shaft with respect to each other to thereby perform a cutting operation, and
a spring nut secured on an outer surface of said second cutting blade and engaged with said support shaft, and
cutting operation means engaged with at least one of said handle of said first cutting blade and said handle of said second cutting blade, for causing said second cutting blade and said first cutting blade to perform said cutting operation, by way of said at least one of said handle of said first cutting blade and said handle of said second cutting blade;
printing means for printing a portion of said tape material as desired; and
tape-feeding means for feeding said tape material printed by said printing means to bring a printed portion of said tape material to said cutter mechanism.

14. Scissors comprising:
a pair of cutting blades each having a handle and arranged for relative rotation with respect to each other to thereby perform a cutting operation, said pair of cutting blades each having a cutting edge and a cutting face parallel with said cutting edge; and
a pivot member about which said pair of cutting blades perform said relative rotation;
each of said cutting blades having a bent portion along said cutting edge, said bent portion formed by bending a portion including said cutting face toward an opposed one of said cutting blades at a predetermined angle.

15. Scissors according to claim 14, wherein said predetermined angle is within a range of five to eight degrees.

16. Scissors according to claim 14, wherein said bent portion is formed in a manner such that said bent portion increases in width from a root of said each of said cutting blades to a tip of said each of said cutting blades.

17. Scissors according to claim 14, wherein said pivot member comprises a support shaft pivotally connecting said pair of cutting blades, said each of said cutting blades having a cutout portion formed at a root of said bent portion in a manner such that said cutout portion is recessed from said cutting edge toward a back edge side in excess of a width of said bent portion.

18. Scissors according to claim 14, wherein said pivot member comprises a support shaft pivotally connecting said pair of cutting blades, one of said cutting blades to which said support shaft is secured being formed therethrough with an insertion hole, and having a spring nut portion formed in the form of a spring nut on an inner peripheral surface of said insertion hole.

19. Scissors according to claim 14, wherein said each of said cutting blades is formed by blanking and bending of a plate material.

20. A cutter mechanism comprising:
scissors including:
a pair of cutting blades each having a handle and arranged for relative rotation with respect to each other to thereby perform a cutting operation, said pair of cutting blades each having a cutting edge and a cutting face parallel with said cutting edge, and
a pivot member about which said pair of cutting blades perform said relative rotation,
each of said cutting blades having a bent portion along said cutting edge, said bent portion formed by bending a portion including said cutting face toward an opposed one of said cutting blades at a predetermined angle; and
cutting operation means engaged with at least one of said handles of said pair of cutting blades, for causing said pair of cutting blades to perform said cutting operation by way of said at least one of said handles.

21. A cutter mechanism according to claim 20, wherein said pair of cutting blades each bent about said support shaft in a plane of said relative rotation of said pair of cutting blades.

22. A printing apparatus comprising:
a cutter mechanism for cutting off a tape material to a predetermined length, said cutter mechanism including:
scissors, said scissors including:
a pair of cutting blades each having a handle and arranged for relative rotation with respect to each other to thereby perform a cutting operation, said pair of cutting blades each having a cutting edge and a cutting face parallel with said cutting edge, and
a pivot member about which said pair of cutting blades perform said relative rotation,
each of said cutting blades having a bent portion along said cutting edge, said bent portion formed by bending a portion including said cutting face toward an opposed one of said cutting blades at a predetermined angle, and
cutting operation means engaged with at least one of said handles of said pair of cutting blades, for causing said pair of cutting blades to perform said cutting operation by way of said at least one of said handles;
printing means for printing a portion of said tape material as desired; and
tape-feeding means for feeding said tape material printed by said printing means to bring a printed portion of said tape material to said cutter mechanism.
